(19) United States
(12) Patent Application Publication
(10) Pub. No.: US 2016/0243762 A1
(43) Pub. Date: Aug. 25, 2016

(54) AUTOMATED DESIGN, SIMULATION, AND SHAPE FORMING PROCESS FOR CREATING STRUCTURAL ELEMENTS AND DESIGNED OBJECTS

(71) Applicant: Robert J. Fleming, San Jose, CA (US)

(72) Inventors: Robert J. Fleming, San Jose, CA (US); Daniel Vasquez, San Jose, CA (US)

(21) Appl. No.: 15/144,767

(22) Filed: May 2, 2016

Related U.S. Application Data
(63) Continuation-in-part of application No. 14/543,772, filed on Nov. 17, 2014.
(60) Provisional application No. 62/179,239, filed on May 2, 2015.
(60) Provisional application No. 61/905,052, filed on Nov. 15, 2013.

(51) Int. Cl. B29C 67/00; G05B 19/4099; G06F 17/50

(52) U.S. Cl. CPC B29C 67/0066; B29C 67/0085; G06F 17/50; B29C 67/0088; G05B 19/4099; B33Y 30/00

(57) ABSTRACT

A three-dimensional printer, system and method is provided for individually creating three-dimensional structural elements (individually termed fundamental structures) which are sequentially positioned into formation of a shaped object.

### RELATED APPLICATIONS

This application claims benefit of priority to U.S. Provisional Patent Application No. 62/179,239, filed May 2, 2015. This application is also a continuation-in-part of U.S. patent application Ser. No. 14/543,772, filed on Nov. 17, 2014, which claims benefit of priority to U.S. Provisional Patent Application No. 61/905,052, filed Nov. 15, 2013. The aforementioned priority applications are hereby incorporated by reference in their respective entireties.

### TECHNICAL FIELD

Embodiments described herein relate generally to a shape forming process, and more specifically, to a shape forming process, compositions, and applications thereof for creating structural elements and designed objects.

### BACKGROUND

Composites refer generally to a heterophase material containing a binder and a solid. A growing class of structural composites consist of an organic polymer binder or “resin” and a filament or fiber, typically composed of glass, carbon, or natural fibers such as flax or hemp. In some variations, the fiber or filament can be formed from metal. The fiber is in the form of a filament (continuous or semi-continuous), narrow strips of woven cloth, a bundle or roving, a braid, or cloth made into strips or “tape”. The structural composites industry is growing because of the desire for light weight-high stiffness materials for industries ranging from aerospace to automotive to recreational equipment. Composite materials are typically formed into shape via pre-formed molds that are costly and add to the development cycle time. Typically the steps required to build a composite part include: 1) design a part and mold, 2) make prototype part or [positive image], 3) make mold [negative image], 4) add release agent to mold, 5) add resin and fiber to mold, 6) cure resin, 7) remove final part, and 8) clean or discard mold. These steps consume unnecessary time, materials, and waste adding to the cost of composite parts.

Three-dimensional printing, also referred to as “additive manufacturing” involves the process of designing a three-dimensional object an a CAD software tool (Computer Automated Design), then “slicing” the object into many thin 2C slices using a CAM tool (Computer Automated Manufacturing) designed to generate the programming for slicing and generating the code for motion control. This process for generating three-dimensional objects from layered 2C slices is simple and effective but is limited to certain material sets and does not allow for material property design in the z-axis. It is also difficult to integrate continuous high modulus fibers and high modulus resins into these types of properties. Another problem with traditional three-dimensional printing processes is that the final properties of the finished part are difficult to predict from the material properties fed into the printer.

### BRIEF DESCRIPTION

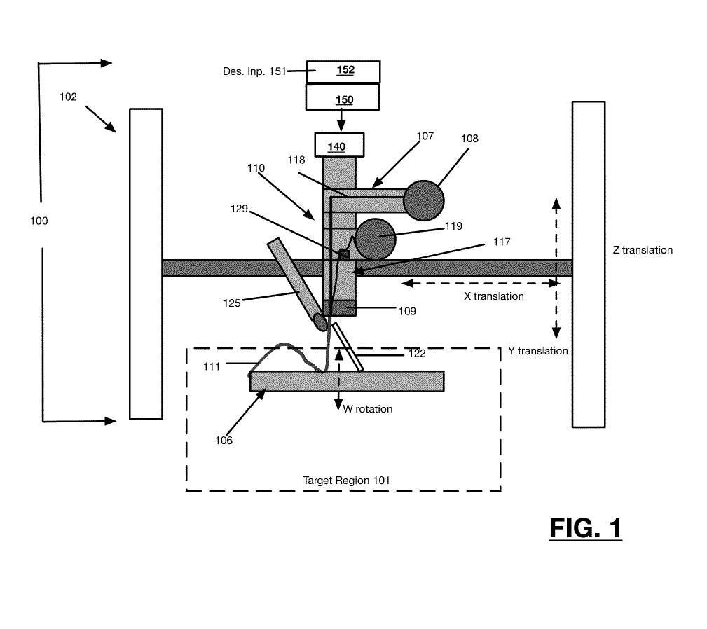

FIG. 1 illustrates a tool for performing a shape forming process and creating a structural element and design thereof, according to an embodiment.

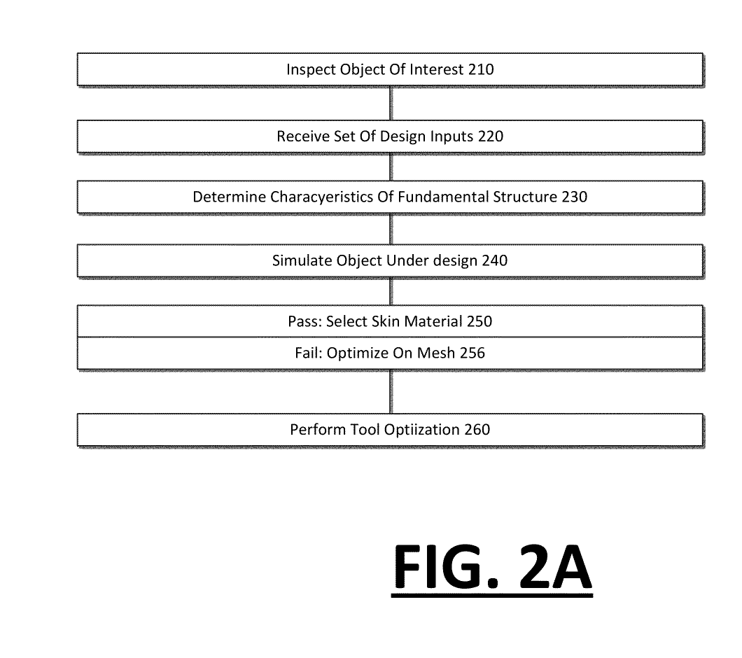

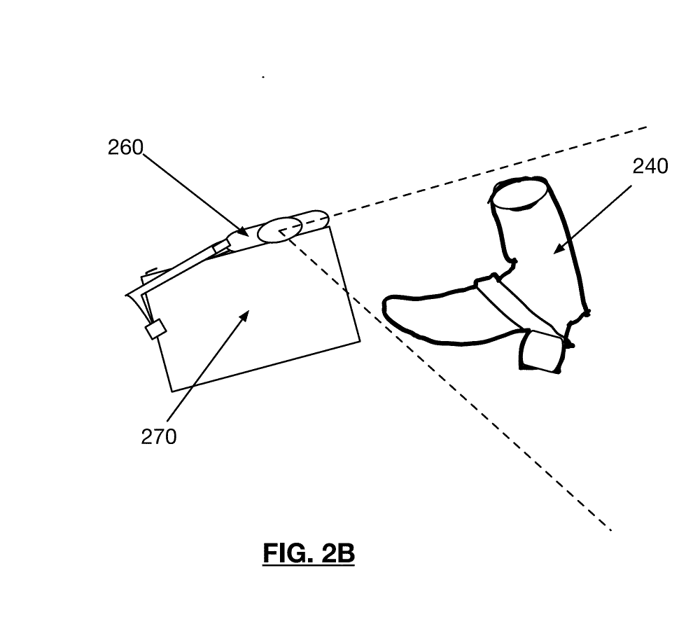

FIG. 2A illustrates an example method for operating a tool, such as described with an example of FIG. 1.

FIG. 2B illustrates an example for scanning an image in order to implement one or more embodiments.

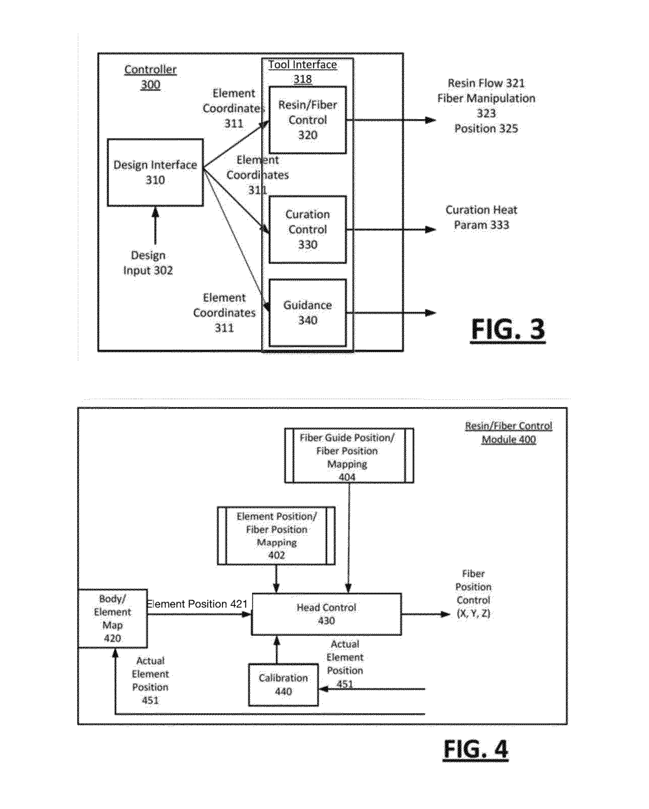

FIG. 3 illustrates a controller for controlling a tool that implements shape forming processes, as described with examples of FIG. 1 and FIG. 2.

FIG. 4 illustrates an example sub-system for implementing resin/fiber control, according to another embodiment.

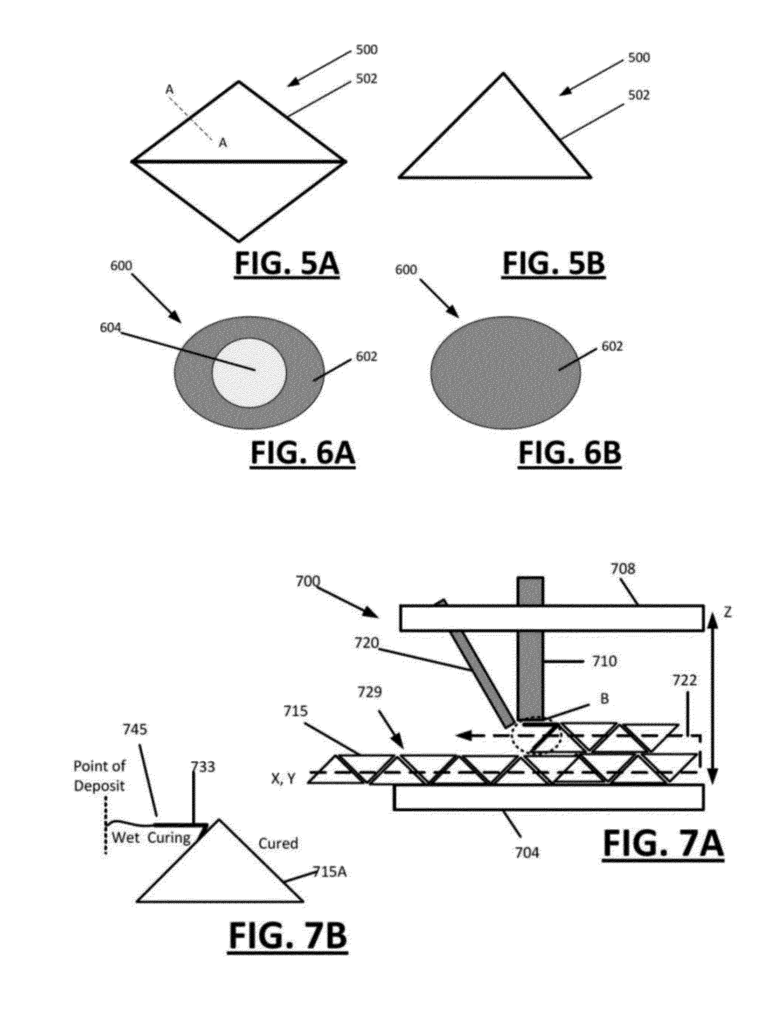

FIG. 5A and FIG. 5B illustrate an example of a structural element that can be produced using a tool such as described with examples of FIGS. 1-4.

FIG. 6A and FIG. 6B illustrate alternative cross-sectional views of a segment of structural element, shown by line A-A, according to another aspect.

FIG. 7A illustrates a tool in operation to stitch structural elements sequentially into a desired object.

FIG. 7B illustrates a close-up of a portion of an object under formation, illustrating a point of formation at a given instance of time during the operation of a tool.

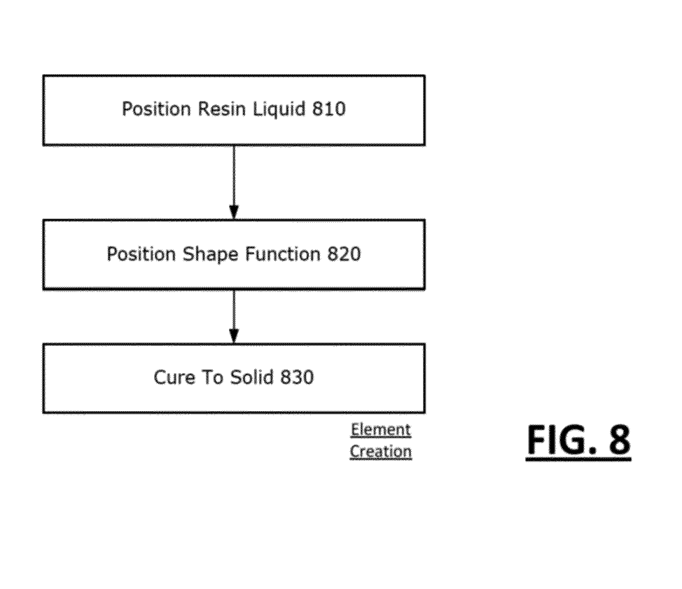

FIG. 8 illustrates a method for forming a structural element, according to an aspect.

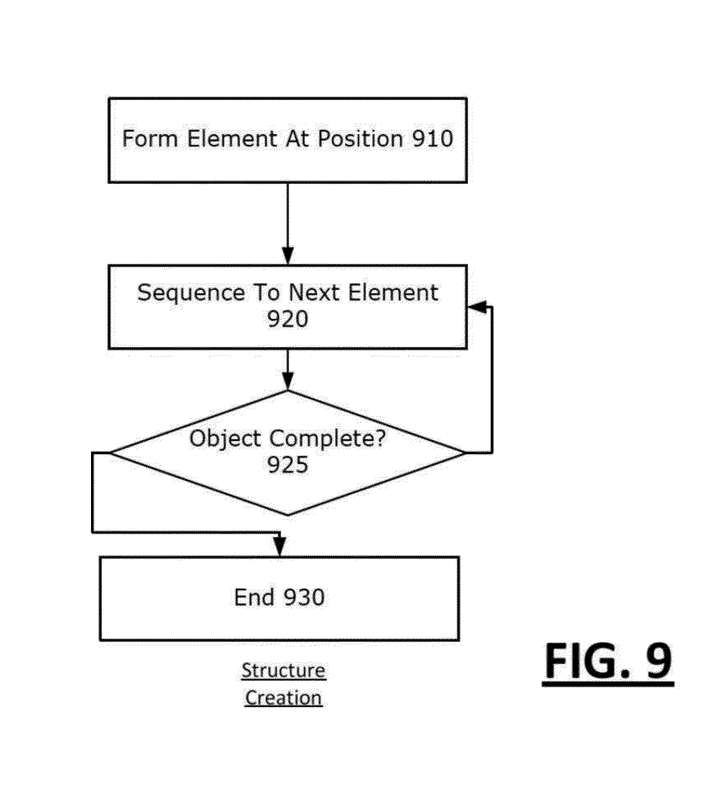

FIG. 9 illustrates a method for forming an object from structural elements, according to another example.

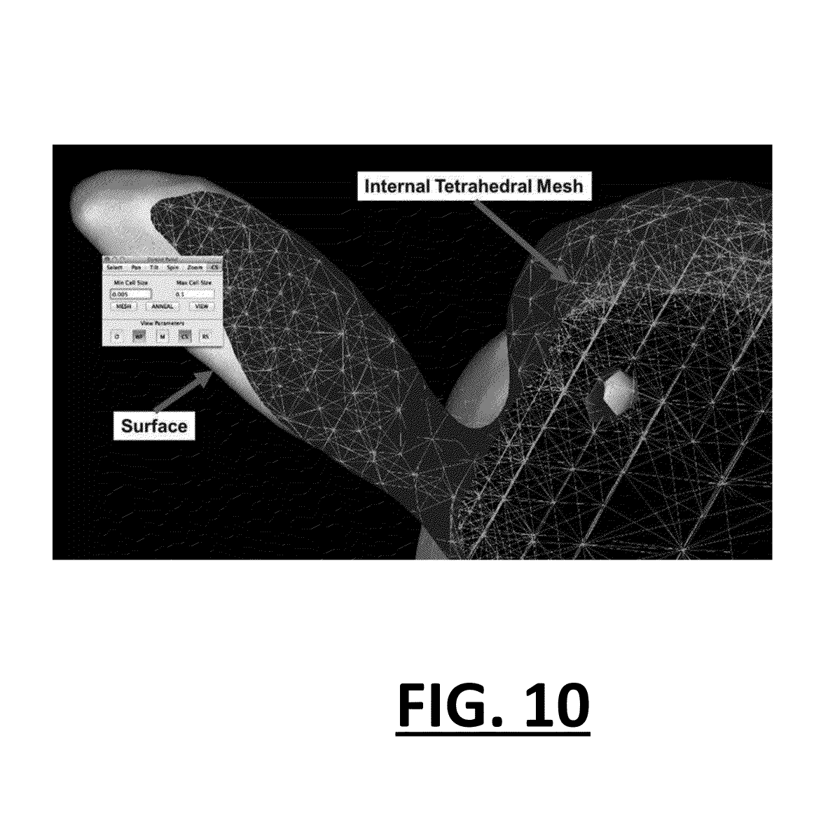

FIG. 10 illustrates an example of a shaped object produced using a structural element such as described with examples provided herein.

### DETAILED DESCRIPTION

Some embodiments include a system and method for creating a shaped or designed object by way of forming three-dimensional structural elements. The system and method includes algorithms for optimizing the structure for desired physical properties such as break strength, stiffness, and weight and/or electrical properties such as electrical routing, sensor or motor placement or other integrated circuitry including logic or light emitting diodes.

In some embodiments, a three-dimensional printer is provided that individually creates three-dimensional structural elements (individually termed fundamental structures) which are sequentially positioned into formation of a shaped object. As used herein, the term “printer” means a device or tool that generates a physical thing.

In one embodiment, a three-dimensional printer includes a resin delivery mechanism, fiber source, a curation mechanism, and a controller (or tool interface). The fiber source may provide fiber that is concentrically combined with the resin. A curation mechanism cures the resin and/or fiber at a given position of a target location. A controller manipulates the resin and/or fiber into a desired shape, while the curation mechanism cures the resin and/or fiber in position.

In another embodiment, a tool is provided to create fundamental structures, which can be aligned sequentially (using common fiber and coating (e.g., resin)) to form the shaped object. The tool can form a fundamental three-dimensional object by placement of a coated fiber length on a target region. As described in various examples, the coating provided by the fiber may include resin, or other materials, such as conductive material. In forming the fundamental object, the tool can extend a fiber length into the sequence of multiple fundamental objects, aligned to form a shaped object (e.g., mold for holding building material, boats etc.).

Still further, some examples include a tool includes a delivery sub-system and a curation and cutting mechanism. The delivery sub-system is provided that separately combines a coating and a fiber to form multiple frames in continuity on a target region. The curation and cutting mechanism to cure and cut individual frames formed on the target region, so as to create an aggregation of fundamental structures that collectively form a portion of a desired shaped object.

Algorithms are also provided to optimize the element properties, structure, size, shape, density, and placement for finished shape properties such as physical break strength and stiffness. Algorithms are also provided to optimize the fabrication tool path to maximize fabrication speed, element fabrication order, skin profile, minimize defects such as fiber cuts, and the like.

As used herein, the term three-dimensional in the context of an element, structure or other object is intended to mean an element, structure or other object having a dimension in each of three axes (e.g., Cartesian reference frame) which are of at least a same order of magnitude. A three-dimensional element, structure or object, for example, is intended to be distinguishable from a layer or film, which has thickness of one or more orders of magnitude less than its other two dimensions.

Examples as described more generally enable creation of a lightweight, yet strong composite structure. As such, some examples may have specific application for use in forming a designed object that corresponds to a mold or article for enabling retention of concrete or other building materials. Still further, other examples enable for creation of objects such as hulls (e.g., boat hull) and trusses, and/or molds for creating hulls and trusses.

Still further, in some examples, a process is provided for producing an optimized three-dimensionally shaped object. As part of the process, a computer designed object is received, from which a mesh structure is generated. The mesh structure is generated based on a series or alignment of fundamental structures. In some examples, the shaped object is formed with fundamental structures that are positioned in a manner that optimizes use of a tool path for generating said shaped object. A tool (or printer) can be operated under control to generate the designed object, using the selected fundamental object and the optimized tool path.

In some examples, features such as inclusion of material as external skin material is provided.

In forming the sequence of fundamental objects, the tool may cut objects formed in a target region for dimension, accuracy etc. An optimization may be implemented for operating the tool that takes into account a number of cuts required to produce a shaped object.

The physical, aesthetics, or electrical characteristics of the shaped object can be accentuated (or optimized) for various properties, such as break strength, stiffness conductivity (or resistivity). Such characteristics can be accentuated or optimized through selection of geometric shape and dimension for the fundamental object, as well as selection of coating and fiber material, and optionally surface skin material and definition. By way of example, the fundamental structure may be in the form of a tetrahedron, a pyramid, or a square/cube shape.

In other examples, the coating can be in the form of a resin that contains reactive vinyl, acrylate, or epoxy groups.

The types of shaped objects that can be formed include, for example, a printed circuit board (with three-dimensional shape), a prosthetic, a building structure, a machine element (e.g., for vehicles, planes, drones), a boat hull, or a mold. The mold can, for example, include molds for specialized structures, such as molds for creating shaped concrete building blocks or segments.

FIG. 1 illustrates a system for performing a shape forming process and creating a structural element and design thereof. According to an example of FIG. 1, a system 100 includes a tool 102, which can be controlled through a controller (see FIG. 3) of a tool interface 140. The tool interface 140 may receive inputs from a design interface 150. In this way, the tool 102 can create a designed object from individual, three-dimensional structural elements of a desired shape. With reference to an example of FIG. 1, a system and/or tool may be used to form a shaped object by (i) separately combining a coating and a fiber to form multiple frames in continuity on a target region; and (ii) curing and cutting individual frames formed on the target region, so as to create an aggregation of fundamental structures that collectively form a portion of a desired shaped object.

According to examples, a designed object refers to any object designed by a user of the tool 102, having structural and geometric characteristics specified by design parameters. By way of example, a designed object can correspond to a shaped circuit board for carrying electronic circuitry and components in an electrically operable matter. The design parameters can, for example, specify a thickness, a contour, a shape, and an overall dimension of the shaped circuit board. Design parameters can also, for example, specify physical structural properties such as load bearing capacity and stiffness as well as density or weight.

With reference to an example of FIG. 1, the tool 102 operates to form a design object by sequentially creating individual structural elements on-site of the object while it is being formed. In this respect, the tool 102 can operate as a three-dimensional printer, but in contrast to conventional approaches which form two-dimensional layers into a finished object, an example tool 102 of FIG. 1 individually creates three-dimensional structure element on site of the object being formed. Among other benefits, the resulting object can enable a more diverse range of designed objects having structurally sound characteristics. Additionally, some variations enable structural elements to include integrated conductivity, which can result in a three-dimensional shaped object with inherent electrical characteristics or ability. Additionally shapes can be formed with large void spaces leading to parts with high stiffness and strength but also low weight.

In an embodiment, tool 102 includes a delivery system 110 that couples resin with fiber to form a structural element. In more detail, tool 102 includes a three-dimensional positioning apparatus that can provide X-Y-Z positioning and a rotational stage 106. The sample being formed is on a rotatable stage to provide a three-plus axis positioning system. The positioning stage 106 can in turn support retention and shaping of an object being formed, such as a shaped structural composite part, circuit board or electrical element. One or two axis of rotation can be added to the print head in addition to or in replace of the rotatable stage.

In one embodiment, the delivery sub-system 110 includes a resin delivery mechanism 107 and a fiber delivery mechanism 117. According to some examples, the resin delivery mechanism 107 and the fiber delivery mechanism 117 separately deliver resin and fiber respectively, where the resin and fiber are combined for delivery to a target region 101. The 107 can deliver a pre-determined amount of resin from a resin source 108 through a conduit 118 to the target region 101. By way of example, the resin delivery mechanism 107 can include one or more of a metering pump, such as a syringe pump, peristaltic pump, gear pump, air pressure, or progressive cavity pump. A pump, for example, can deliver resin in liquid form to a head that deposits a resin portion onto a substrate provided at the target region. The resin delivery mechanism 107 can deliver the resin in a heated and/or vibrated state to maintain a minimum viscosity of the resin. In some examples, the delivery sub-system 110 includes a head 109 that can be cylindrical, flat, round or elongated, depending on the desired resin “drop” characteristic and material. While an example of FIG. 1 makes reference to a coating for a fiber as resin (or polymer composite), numerous variations provide for other types of coating material to be used in place of or with resin (e.g., conductive material). The type of coating used may be selected in part based on a desired electrical and/or physical characteristic desired from the fundamental structure.

Prior to arrival of the coating, the fiber delivery mechanism 117 delivers the fiber from a fiber source 119 (e.g., spool, the spool does not have to be mounted on the robotic arm or delivery head) to engage a fiber manipulation mechanism (as shown this should stop at the object being shaped). In some examples, the fiber is twisted, braided or manipulated by a manipulator 129 prior to the fiber encountering the resin within or outside of delivery sub-system 110. The fiber source 119 may alternatively carry twisted or braided fiber. Still further, at the target region 101, a fiber guide 122 manipulates the fiber in three dimensions (plus one or more rotational axis) in order to manipulate the fiber into a desired frame 111. The frame 111 becomes a fundamental structure once cured. As described with other examples, the tool 102 can generate a sequence of fundamental structures in order to generate a designed object (e.g., mold, shaped object).

According to some examples, the system 100 may include a cutting tool such as a mechanical knife or laser for when the resin/fiber is cured during the process of forming an element or finished part. As another variation or addition, the frame 111 can be further manipulated through twisting or braiding at the target region, after coating takes place. In some examples, the twisting or braiding takes place before the frame 111 is cured.

In one embodiment, the resin is delivered by the resin delivery structure 107 into the fiber guide 122 at the target region 101. In one implementation, a curing process is performed to cure the liquid resin in place (e.g., over the frame 111). The curing process can utilize, for example, an visible, infrared, or ultraviolet Light (UV) light source. In some examples, a UV laser 125 acts as a curing source and a cutting tool by altering the UV laser power for the intended use. The UV laser power can be altered between “cutting” mode and “curing” mode by either reducing the output power of the laser, imposing a mechanical shutter that is graded to reduce the power, or optically to refract or absorb some of the laser power. Optionally the finished part can be post cured in an oven or UV “light box” to finish the cure and build optimal properties. The cutting and curing tools can optionally be combined into a single laser. For example, a UV laser can be employed to cure the resin and fiber into desired shape and also cut the cured resin and fiber. Optionally the UV laser can be reduced in power by lowering the laser power or by optical methods such as refraction, scattering or adsorption to allow for proper resin curing, then the UV laser power can be increased by increasing power or eliminating optical power reduction methods and cutting the fiber-resin.

Examples of suitable resins include monomers with acrylate, epoxide, or vinyl reactive groups and resin formulations include thermally induced free-radical, UV photoinitiators or cationic UV photoinitiators. Optionally, the radiation source can induce heat, for example from infrared radiation, and the resin can be thermally cured. More preferable the initial curing is with UV to provide initial shaping and a post-shaping cure step with thermal or infrared radiation is employed to build excellent physical properties. Among other achievements, an embodiment provides that the resin combines intimately with the fiber after contact with the fiber and then quickly becomes a solid or semi-solid after start of the curing event. In order to minimize curing shrinkage that can occur with polymerization blends of acrylate and/or epoxy and/or vinyl and/or isocyanate, functional resins can be combined with mixtures of free-radical photoinitiators and cationic photoinitiators. Also UV curable resins containing or combinations of vinyl, acrylate, vinyl ether, vinyl ester, or epoxy groups can be combined with resins containing moisture or thermally curable groups such as isocyanates. Examples of epoxy materials include Epon 828 from Momentive Inc., Vinyl materials include Derakane 441 from Ashland Chemicals Inc., and examples of acrylate functional materials include Sartomer CN117 from Arkema Inc. The resin is coated onto a fiber that includes glass fiber, a natural fiber from, for example hemp or flax, or carbon nanotubes, or metal wire filament, for example copper, that are spun, drawn, twisted or somehow formed into a continuous fiber. Optionally the same or different types of fibers or filaments could be formed together into a single continuous unit or fiber, for example, by twisting, weaving, or braiding together. This blended or mixed fiber would be dispensed, coated with resin, and shaped into an element. Multiple elements would be formed to build a shaped object. The fibers or filaments could also be optionally coated, or surface treated in a step prior to the resin coating step for shape forming. This step could include “priming” or coating a thin layer of a polymer, monomer, oligomer, coupling agent, or the like to modify the properties between the shaping resin and fiber. The properties could be for adhesion, conduction, impact modification, or the like. Also a fiber could be coated with smaller fibers, like nanotubes i.e carbon nanotubes, or nanoparticles, i.e. silica nanoparticles.

According to some examples, the system 100 is operable under control of a design sub-system 150. The design sub-system 150 includes an interface 152 to receive a set of inputs 151 form a designer. The set of inputs 151 may specify (i) an object to be produced, and (ii) one or more functional requirements of the object. The design sub-system 150 may communicate input 151 to a tool interface 140, which in turn controls operation of the system 100 to enable formation of fundamental structures resulting from the curing and/or processing of the frame 111.

FIG. 2A illustrates a method for operating a tool such as described with FIG. 1, according to one or more embodiments. A method such as described with an example of FIG. 2A can be implemented using, for example, a controller of an example of FIG. 3, and more specifically, a design interface and tool interface such as shown and described with FIG. 3.

In one implementation, an object of interest is identified and parsed or inspected for physical characteristics and attributes (210). In one implementation, an image of an object of interest is imported and subjected to image analysis. In a variation, a three-dimensional (or depth) image is captured or otherwise utilized as input for identifying and inspecting the object of interest.

A set of design inputs may be received from the designer/user (220). The design inputs can specify a variety of functional characteristics or attributes of the object being formed, including: overall shape, strength (compression, tensile), stiffness, break strength, elasticity, weight, electrical conductivity or other characteristics, etc.

From the functional characteristics of the object being formed, the design interface 310 (see FIG. 3) can make one or more programmatic determinations about the fundamental structure(s) which comprise the object that is to be shaped (230). In particular, one or more physical and/or electrical characteristics can be selected or otherwise determined for a fundamental structure. These include, for example, shape of fundamental structure, dimension(s) of fundamental structure, dimension or material of fiber for forming the fundamental structure, electrical characteristics of the fiber, packing density of a layer or thickness of the fundamental structure, etc.

A simulation of the object under design can be done using the fundamental structure, with the selected characteristics or properties (240). The analysis can, for example, include stress and/or electrical analysis using software modeling.

If the object under design “passes” simulation, then a skin material can be selected (250). The skin material can itself be selected for physical (e.g., smoothness, tensile strength, etc.) and/or electrical characteristics (e.g., insulation). If the analysis does not yield a pass, then mesh optimization is performed to realign the fundamental structures so that the object under design has better physical and/or electrical properties (256).

Additionally, tool optimization can be planned (260). The tool optimization can select tool path to avoid crisscross movement of the fiber feed, for example. Additionally, the optimization can minimize a number of cuts needed in order to transform an intermediate structure into a more final structure.

The design interface (e.g., see 310 of FIG. 3) can then signal instructions to the tool (e.g., via the tool interface 318, as shown with an example of FIG. 3) to form the desired object using the fiber and resulting fundamental structure of the determined characteristics.

FIG. 2B illustrates an aspect of an example design flow in which an object 240 is scanned in using an image scanning tool 240 that provides a three-dimensional image of the part.

As described with an example of FIG. 3, the computer 250 can operate to generate a mesh by aggregating the basic elements (i.e. tetrahedral) to form the final shaped object or part. The shape is then analyzed for its physical and/or electrical properties then optimized based on its targeted final properties. Then the tool path is optimized for successful part generation, fabrication speed, and minimal defects.

FIG. 3 illustrates a controller for controlling a tool that implements shape forming processes, as described with examples of FIG. 1. For example, the controller 300 can be implemented as a programmatic or computer-driven mechanism to control precision movements and timed actions of tool 102 (FIG. 1). With respect to an example of FIG. 1, the controller 300 can be implemented as part of the tool interface 140.

In an embodiment, controller 300 includes a design interface 310, and a tool control interface 318. The tool control interface 318 includes functionality for providing or otherwise implementing one or more of a resin/fiber control 320, curation control 330, and guidance 340. The tool control interface 318 can receive input based on design inputs, which the design interface signals as parameters to the tool control interface 318. From the design interface 310, one or more decisions can be made about the fundamental structure, including material selection (for physical and electrical characteristics), geometric selection, and dimensional selection (including density) are made. In some variations, the controller 300 can also include a simulation interface which can simulate the creation of a shaped object, with physical and electrical attributes provided through optimization of the fundamental structures.

The design interface 310 can receive or determine design input 302 (or design parameters), which can specify structural physical and/or electrical characteristics of a desired object, such as a shaped circuit board, an airplane wing, a car bumper, or a prosthetic limb, for example. The design inputs 302 or parameters can also specify structure elements, including a desired size and/or shape of a structural element. The simulation interface can simulate the expected physical properties and optimize to meet design targets such as stiffness, break strength, or electrical pathways. The simulation will then provide feedback to the design interface to make necessary improvements, optimizations to the design. As described with other examples, structure elements can be sequentially formed and combined using the tool 102, so as to form the desired object.

Based on the design input, design interface 310 can generate parameters for forming structural elements. Furthermore, the design interface 310 can generate a free space coordinate and dimension corresponding to the three-dimensional object that is to be formed. Based on the determinations, the design interface 310 can signal element coordinates 311 to resin/fiber control 320, curation control 330 and guidance 340. The element coordinates 311 identify discrete locations in three-dimensional space in a region of the target. The guidance 340 can implement discrete and precision movement of the delivery head, for example, so that, for example, the resin/fiber delivery mechanism can deposit and cure resin at each specified coordinate in a sequential manner.

The resin/fiber control 320 can receive the element coordinates 311 and implement processes to produce a shaped structural element at the target location. In particular, the resin fiber control 320 can generate control parameters for the output and use of the resin and fiber combination. The parameters can include a resin flow 321 parameter, which specifies the volumetric flow rate of resin at individual discrete locations, specified by the coordinates 311. Another parameter that can be specified is fiber manipulation 323, which specifies a geometric shape, dimension or set of dimensions for a geometry of the structural element being formed. Still further, the resin/fiber control 320 can generate a parameter position 325, identifying in orientation and/or pinpoint location of a particular structure element to be formed, a view of coordinates 311. Likewise, the curation control 330 can generate a curation parameter 333, which can specify an output power, a temperature (if heat source is being used) or radiative power if a light source is being used, intensity, and/or duration of the curing energy source on the resin fiber combination. Still further, the controller can control cutting the resin/fiber, for example by turning on a laser, altering laser power between cutting and curing, or actuating a mechanical shearing device.

The movement accomplished by the guidance 340 can correspond to a sequential traversal of coordinates in a defined three-dimensional space of an object under formation. In this way, the coordinates 311 can identify a sequence of coordinates where a structural element is formed by deposit of resin/fiber, followed by curing.

FIG. 4 illustrates an example sub-system for implementing resin/fiber control, according to another embodiment. A resin/fiber control module 400 of FIG. 4, for example, can be implemented as part of controller 300 (see FIG. 3). In one embodiment, resin/fiber control module 400 includes a body/element map 420, a head control 430, and a calibration component 440. The body/element map 420 generates the position coordinates that can control the guidance 340 (see FIG. 3). In particular, the body element map 420 signals element position 421 to the head controller 430. The element position 421 can correspond to a cord in three-dimensional space above the target location where the next structural element is to be formed. The head control 430 can implement mapping (e.g., element position to fiber position mapping 402) in order to determine position information for placement of the resin/fiber combination. In a variation in which a fiber guide is used, the mapping can determine the position of the fiber guide relative to the fiber position mapping. In turn, the fiber position mapping can be determined from a map to the element position coordinates.

An observation component 450 can be optionally included with the resin/fiber control module 400. The observation component 450 can include sensors, such as optic-based sensors, which can sense information about the placement of structural elements at the target region. In one implementation, the calibration component 440 receives data that indicates actual element position 451. The actual element position 451 can differ from the output of, for example, design interface 310 (see e.g. FIG. 3) in that the actual deposit location of the structural element at a given instance may fluctuate slightly from the intended position. Such discrepancies can build up over time and skew or otherwise misaligned the structure. The observation component 450 can generate the actual element position 451 for use by calibration component 440. The actual element position 451 can, for example, skew or otherwise adjust implementation or performance of the head control 430, so that subsequent use of the head control 430 includes adjustments that accounts for misaligned or mis-positioned structural elements.

FIGS. 5A and 5B show an example of a fundamental structural element 500, a tetrahedron, that has shape in 3 dimensions, for example in length, width, and height. The fiber/resin delivery system, 3-axis motion control, and rotational stage all act together to properly form all sides 502 of the tetrahedron physical properties. This fundamental element comprises the basis for forming larger pre-determined structures.

While an example shown provides for tetrahedron-shaped structural elements, other three-dimensional shapes can alternatively be used, such as structural elements that are box-shaped, structural elements with an octagonal (or other polygonal) or circular/rounded base, pyramidal, 3D-Kagome, diamond, square, cube, corrugation, honeycomb, or the like.

FIG. 6A and FIG. 6B illustrate alternative cross-sectional views of a segment 600 of structural element 500, shown by line A-A, according to another aspect. As the structural element 500 includes segments 600 that are uniformly present and made from common material (e.g., resin, or resin with fiber center), the cross-sectional representation of FIG. 6A and FIG. 6B can represent any portion of structural element 500. In an example of FIG. 6A, the segment 600 is composed of a resin shell 602 and a fiber core 604. The fiber core 604 can be formed from high modulus material, having fiber dimensions. In one embodiment, the fiber is comprised of individual filaments and are selected to be of around 1-200 microns in diameter, and more specifically, between 5-10 microns. In variations, the fiber core 604 can have a diameter of the order of 10 micron or less. Still further, in another variation, the fiber core 604 is a bundle of fibers or filaments, such as multiple thin filaments, each of which are 10 microns. The filaments comprise fibers (e.g., sometimes called a “roving”) which combined comprise a fiber core being 0.5 mm in diameter. In one implementation, the fiber coated with resin ends up at around 1 mm when cured.

With further reference to an example of FIG. 6A, the fiber core 604 can be composed of glass, carbon or natural materials. By way of example, the fiber core 604 can be in the form of a filament (continuous or chopped), woven cloth, or made into strips or “tape”. In some variations, the fiber core 604 is formed from conductive material. For example, the fiber core 604 can include conductive traces or powder.

The resin 602 can be formed from, for example, an organic polymer binder or blend, including resin formulations that include free-radical UV photoinitiators or cationic UV photoinitiators. Still further, in some variations the resin includes conductive material or powder. Still further, the resin can include metal particles that are sintered with a laser. Among other benefits, examples such as provided herein enable a thickness and volume of each layer of a shaped (or printed) object to be adjusted significantly (e.g., by order of ten) simply by increasing a diameter of a fiber bundle. For example, fiber bundles can have their diameters increased from 1 mm to 4 mm, and further to 10 mm. The variation in the diameter size of the fiber bundle can be achieved through, for example, material selection, or by twisting or braiding the fiber (e.g., when it is extracted from the tool 102).

With reference to FIG. 6B, a variation is shown in which the unit includes resin and no fiber. In such a variation, the fiber can be used to shape the resin from the exterior while the resin is cured.

FIG. 7A illustrates a tool in operation to stitch structural elements sequentially into a desired object. The tool 700 can be structured the same or similar to other examples (e.g., tool 102 of FIG. 1). The tool 700 includes a stage 704, a support structure 708, a curation mechanism 720 and a resin/fiber delivery mechanism 710. The stage 704 can receive and retain portions of an object being constructed in 3 dimensions. For example, object 705 can represent a partially formed object (e.g., sometimes referred to as a body) that can extend in height (along axis Z) and lateral dimensions (X, Y) on the stage 704. The support structure 708 supports curation mechanism 720 and resin/fiber delivery mechanism 710 in an operable position above the stage 704. The curation mechanism 720 and resin/fiber delivery mechanism 710 can be positionable by the robotic arm over the stage 704 at a selected height and lateral position. As described with an example, the support structure 708 can position the curation mechanism 720 and the resin/fiber delivery mechanism 710 at discrete pinpoint locations dictated by the controller 300 (see FIG. 3) based on design input.

With reference to an example of FIG. 7A, the support structure 708 can move the curation mechanism 720 and the resin/fiber delivery mechanism 710 sequentially from position to position in a three-dimensional space above the stage 704. At each location, a structural element 715 can be formed from the linear placement (in three-dimensions) of fiber/resin, as deposited by the resin/fiber delivery mechanism 710. The precision movement of the support structure 708 can enable a tool-path pattern 722, which defines the sequenced positions of the curation mechanism 720 and the resin/fiber delivery mechanism 710. Structural elements 715 can be formed on other structural elements in accordance with a predetermined sequence of positions, shown as stitch pattern 729, in order to form an object 729. The tool-path pattern and order of formation of structural elements are optimized using algorithms invented herein.

As shown by the example of FIG. 7A, the tool-path pattern 722 can define both the position and orientation of each structure element 715. For example, structure elements having a tetrahedron type shape can be formed end-to-end along a line, but the adjacent space between formations defines a triangular gap or space.

FIG. 7B illustrates a close-up of a portion of the object 729, illustrating a point of formation at a given instance of time during the operation of tool 700. As shown by an example of FIG. 7B, individual structural elements 715 can be formed on other structural elements. The fiber/resin delivery mechanism can, for example, deliver a linear segment 733 onto an existing structural element, in order to initiate formation of the adjacent structural element. The curation mechanism 720 can provide instant curation, so that initially placed material 722 of the linear segment 746 under formation is solidified in place.

According to examples, to curation mechanism 720 provides instant curing of resin. Thus, in the example provided, the structural element 715 A can provide a base for a newly added segment 745. The curation mechanism 720 can provide instance curation, using, for example, a UV source, radiation source, lighting source, or even Infrared source. The curation mechanism 720 can, for example, provide instant (or near instant) curation following the deposit of the resin. This results in the rapid formation of dry or semi-dry segment 733 on the existing structural element 715A. In this way, the newly formed segment 745 is integrated with the previous structure, which was cured to receive the newly deposited segments.

FIG. 8 illustrates a method for forming a structural element, according to an aspect position (and fiber) then cure for form shaped position then move to next position. FIG. 9 illustrates a method for forming an object from structural elements, according to another example. An example method such as described by FIG. 8 or FIG. 9 can be implemented using components described with previous examples. Accordingly, reference may be made to components of prior examples for purpose of illustrating a suitable component for performing a step or sub step being described.

With reference to FIG. 8, a structural element can be formed by positioning a delivery mechanism to deposit resin in liquid form (810). The resin can be deposited as, for example, either a homogeneous thickness (e.g., see FIG. 6B) or as a resin/fiber combination (e.g., see FIG. 6A). By way of example, the resin can include a monomer with one or more of acrylate, epoxide, or a vinyl reactive group.

As deposited, the resin is shaped into the desired geometry (820). In one embodiment, the resin can be shaped by the fiber, which provides an exterior force. Accordingly, under one implementation, the fiber can be manipulated to shape the deposited resin. The desired geometry can be pre-selected based on, for example, material characteristics of the resin and/or desired characteristics of the structural element.

In order to enable shaping, the resin can be cured into solid form (830). The curation can occur near instantly after the resin (or resin/fiber) is deposited. The result is the formation of a structural element comprising a material having a rigid and stable three-dimensional shape, formed in part by curing the material from a liquid state in free space. The material of the structural element can be homogeneous (e.g., resin only) or heterogeneous (e.g., resin with fiber and/or conductive particles).

A structural element of FIG. 9 can be uniformly integrated with other structures by sequential formation, such as provided through a stitch pattern. More specifically, with reference to FIG. 9, a structural element is formed in position, as dictated by coordinates generated from the controller 300 (e.g. see optimized tool-path pattern) (910). The next element is formed in sequence based on the predetermined sequence or stitch pattern (920). Once the object (or designated portion thereof) is determined to be complete (925), the process ends. Until the determination, the sequence followed and additional structural elements are formed. A result of FIG. 9 includes a structural elements that are unitarily formed into a body. Each structural element includes a material having a rigid and stable three-dimensional shape that is formed into the body by curing the material from a liquid state. In forming the body, each of the structural elements is sequentially formed at a corresponding location of the body (e.g., see FIG. 7A).

### Example

FIG. 10 illustrates an example of a shaped object produced using a structural element such as described with examples provided herein. In FIG. 10, an object is scanned using a structured sensor scanning device then imported into a software program with algorithms that optimize both the physical properties (e.g. structural and electrical) then optimize the tool path for forming the shaped object. In some embodiments, the sections formed using, for example, a three-dimensional printing tool such as described with an example of FIG. 1, with structural elements include a fiber core or resin exterior which optionally carry conductive traces. With conductive core or traces thereof can be designed into electrical patters which can interconnect or ground electrical components or other elements to form, for example, a printed wiring board.

The conductive material and the non-conductive material can be deposited using the same robot and head or different head or robot. The conductive traces could also be formed by depositing metal particles as a powder or in a binder and sintered using a laser.

### Examples

A 3-axis machine with 3 stepper motors and an Arduino microcontroller was purchased from Inventables.com (Shapeoko 2) the system can move about 6 inches in z-direction, and 18 inches in x and y directions. A small reel of S-glass fiber roving purchased from AGY Inc. Aiken S.C. (ZenTron 758-AB-675) was used as the fiber. The glass roving was pulled from a bobbin and pushed through a tube into a feedblock. The individual fiber was around 10-20 microns in diameter and the roving is around 0.5 mm in diameter The glass roving was pushed in a controlled metering fashion using a stepper motor driven soft wheel and a steel bearing. Simultaneously a UV curable liquid resin was metered into the feedblock using a syringe pump. The feedblock is the manifold where the fiber and liquid resin are intimately mixed before shaping and curing to form a solid shape. The fiber coated with the resin was around 1 mm in diameter when cured. A UV light (Omnicure 2000) was aimed at the exit of the feedblock to cure the coated fiber on demand, the basic element produced was approximately 50 mm in x and y dimensions and 20 mm in z dimension.

The Resin Formulation Used:

20 grams of SR494 liquid resin (ethoxylated pentaerythritol tetraacrylate) from Sartomer part of the Arkema Group, 20 grams of CN2101E liquid resin (ethoxylated epoxy acrylate) also from Sartomer, 0.1 grams of Irgacure 819 (UV photoinitiator from BASF Corporation) were mixed with an spatula until the photoinitiator was dissolved in the liquid resin. The liquid resin was loaded into a syringe pump and pumped at the rate of 0.25 ml/minute into a feed block.

An S-Glass roving (758-AB-675 from AGY corporation consisting of multiple individual 15 micron glass fibers (single end to give 735 tex) was pulled off a spool and pushed into the feed block using a stepper motor driving with a soft urethane foam wheel against a steel bearing. The fiber feed rate was approximately 600 mm/min. The resin coated glass fiber roving was UV cured into place with an OmniCure 2000 UV/Visible spot curing system from EXFO Corporation at approximately 40% of total power. The 3-axis stage with the feed block mounted to the head was moved at approximately 600 mm/minute in a shaping patter while the glass roving was pushed into the feed block at approximately the same rate and the liquid resin was pumped into the feed block to coat the resin at approximately 0.25 ml/min and the Omnicure 2000 spot curing light was position to cure the fiber/resin as it exited the feedblock to form a shape. The diameter of the glass roving was approximately 0.15 mm and the diameter of the finished cured polymer coated glass roving was approximately 0.9 mm. The final cured polymer-glass composite was very stiff and not easily bendable.

In a separate example 2 separate glass rovings were twisted separately in one direction then twisted together in a counter-rotating direction to give a diameter of 0.3 mm. This made feed the glass fiber much easier. The liquid resin as above was pumped at 0.6 ml/min and the final diameter of the fiber-resin element was 1.5 mm. In a separate example, instead of twisting the glass fibers, 3 or more glass fibers or rovings could be braided together to make it easier to feed the fiber but also impregnate with liquid resin. Optionally, the liquid resin could be heated and pumped warm to control viscosity and also increase the cured speed. In a separate example the resin was cured with Light Emitting Diodes (LEDs) that emitted light in the UV region. LEDs in the 380 to 420 nm wavelength output range were used but other wavelengths could also be used.

Embodiments described herein can be implemented with any electronic device, including electronic devices that can be custom sized/shaped (e.g., wearable electronic devices). Embodiments described herein can also be implemented as part of customized recreational equipment (i.e. protective gear), prosthetic devices and electronic devices. Also custom body panels for cars, support brackets, chairs, frames, and other structural members could be formed. Customized furniture could be produced or form structures that could be latter incorporated with cement for building structures or bridges. Lighting fixtures or signage could also be created by the incorporation of wiring and light emitting diodes into the designed structures. Examples described herein can also incorporate sections that are rigid and sections that are flexible.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A system for designing a structure, the system comprising:
a design sub-system including an interface to receive a set of inputs form a designer, the set of inputs specifying (i) an object to be produced, and (ii) one or more functional requirements of the object;
wherein the design interface includes logic for selecting, based on the design inputs, one or more physical characteristics of a fundamental structure produced by a fiber in order to meet the one or more functional requirements of the object;
a tool interface to control operation of a tool for producing object; and
a tool, controllable by input from the tool interface, to form a plurality of fundamental structures in accordance with the one or more functional requirements of the object.

2. The system of claim 1, wherein the one or more functional requirements includes compression strength, tensile strength, weight, stiffness, break strength, strain strength and/or elasticity.

3. The system of claim 1, wherein the one or more functional requirements includes a compression or tensile strength, a brittleness factor, and/or an electrical conductivity.

4. The system of claim 1, wherein the set of design inputs includes an image of an object of interest, the object of interest correlating to the object of interest.

5. The system of claim 1, wherein the logic of the design interface selects the fiber based on a physical or electrical characteristic of the fiber.

6. The system of claim 1, wherein the logic of the design interface selects one or more physical characteristics by determining one or more of (i) a geometry of the fundamental structure, (ii) a density of the fundamental structure, or (iii) one or more dimensions of the fundamental structure.

7. The system of claim 6, wherein the geometry is a tetrahedron type structure.

8. The system of claim 6, wherein the geometry is one of a diamond shape structure, cube shaped structure, modified square type structure pyramid.

9. The system of claim 1, wherein the tool interface includes logic to optimize operation of the tool in implementing a tool path of a tool head in order to form the fundamental element from the fiber.

10. The system of claim 1, wherein the tool interface includes logic to optimize operation of the tool by minimizing a number of cuts needed on an intermediate structure to form the object.

11. The system of claim 1, wherein the design interface selects a material of the fiber.

12. The system of claim 1, wherein the material of the fiber is selected for physical characteristics, including one of strength or weight.

13. The system of claim 1, wherein the material of the fiber is selected for one or more electrical characteristics, including conductivity.

14. The system of claim 1, wherein the material of the fiber includes metal

15. A tool comprising:
a delivery sub-system that separately combines a coating and a fiber to form multiple frames in continuity on a target region;
a curation and cutting mechanism to cure and cut individual frames formed on the target region, so as to create an aggregation of fundamental structures that collectively form a portion of a desired shaped object.

16. The tool of claim 15, wherein the delivery sub-system includes one or more manipulators to shape the frame and/or twist, braid or manipulate the fiber before being coated by the resin.

17. The tool of claim 16, wherein the one or more manipulators twist, braid or manipulate the frame on the target region.

18. The tool of claim 15, further comprising:
a controller to control the operation of the tool in forming each of the multiple frames.

19. The tool of claim 18, wherein the controller communicates with, or includes a design interface for receiving design inputs corresponding to a desired shaped object.

20. A method for forming a shaped object, the method comprising:
separately combining a coating and a fiber to form multiple frames in continuity on a target region;
curing and cutting individual frames formed on the target region, so as to create an aggregation of fundamental structures that collectively form a portion of a desired shaped object.
